(19) United States
(12) Patent Application Publication
(10) Pub. No.: US 2016/0102432 A1
(43) Pub. Date: Apr. 14, 2016

(54) Reflective Fabric with Color Printing and Fabrication Method Thereof

(71) Applicants: Guoshun Chen, Taizhou (CN); Zengyou Wang, Taizhou (CN)

(72) Inventors: Guoshun Chen, Taizhou (CN); Zengyou Wang, Taizhou (CN)

(21) Appl. No.: 14/555,709

(22) Filed: Nov. 28, 2014

(30) Foreign Application Priority Data
Oct. 14, 2014 (CN) 201410541356.6

(51) Int. Cl. D06Q 1/10; D06N 3/18; D06N 3/04; D06N 3/14; B29C 70/68; D06N 3/00

(52) U.S. Cl. CPC D06Q 1/10; B29C 70/68; D06N 3/0006; D06N 3/045; D06N 3/14; D06N 3/183; B29L 2009/00

(57) ABSTRACT

The invention discloses a reflective fabric with color printing, including a fabric layer, an elastic resin layer, a color printing layer and glass beads, wherein the fabric layer is connected with the elastic resin layer, the elastic resin layer is connected with the color printing layer, the glass beads are embedded in the color printing layer, and a reflective layer is set on the surface of the glass beads which embedded in the color printing layer. On the premise of maintaining the reflective effect of reflective material, the invention employs a special printing method to give the material the color diversity, allow the reflective material to be rich in color, give the material wider application and longer service life, and make this type of reflective material be better applied in production of fashionable clothing better.

### CROSS-REFERENCE TO RELATED PATENT APPLICATION

The present patent application claims benefit of Chinese patent application No. 201410541356.6 filed on Oct. 14, 2014, the entire contents of which are incorporated by reference.

### FIELD OF THE INVENTION

The invention relates to a reflective fabric with color printing, a reflective fabric with color printing based on glass bead retro reflection technology used for night operation instruction and garment decoration, and belongs to the field of novel material fabrication.

### BACKGROUND

Since the reflective material has special properties of retro-reflection without providing energy by itself, it is widely used in the special fields of highway, spaceflight, night operation and garment decoration. Fabrication of reflective fabric involves a fabrication and combination process of a variety of materials. These materials include an optical reflection element, a bottom layer, a surface layer, a bonding layer and other auxiliary layers. Now, that mostly used in clothing associated industry is the reflective fabric with glass beads as the reflection element.

The existing reflective fabric can not meet development of the garment industry due to its color monotone, generally grey or silver grey or monotone multicolor and low reflection intensity. With the social progress and the advance of the modernized process, people increase pursuit for new garments, present particular requirements for the clothing material processing technology, and continuously improve safety and aesthetic consciousness, so use of reflective materials in clothing is a large fashion trend of international clothing and is the special embodiment of fashion and high grade.

The invention gives the surface of the material the printed patterns with retro-reflection property, bright color and rich content without changing the safety protection property of the reflective material, and makes the material be diverse and suitable for manufacturing various special clothing, textile materials, etc.

### SUMMARY

The invention is to provide a reflective fabric with color printing to solve problems in the above background of the invention.

The invention provides the following technical scheme: a reflective fabric with color printing, including a fabric layer, an elastic resin layer, a color printing layer and glass beads, wherein the fabric layer is connected with the elastic resin layer, the elastic resin layer is connected with the color printing layer, the glass beads are embedded in the color printing layer, and a reflective layer is set on the surface of the glass beads which are embedded in the color printing layer.

Preferably, the fabric layer is blend-woven by one or more of polyester cotton, all cotton, terylene, spandex and acrylon.

Preferably, the elastic resin layer is a thermoplastic polyurethane elastomer layer or an acrylic elastomer layer.

Preferably, the color printing layer is formed by one or more of intaglio printing, silk screen printing, flexography printing, digital printing with transparent ink and combination thereof.

Preferably, the reflective layer is a colorless transparent coated hemispheroid or a grey coated hemispheroid, and the reflective layer has a thickness of 100-200 Å.

Preferably, the glass beads are solid spheroids with both ellpticity and devitrification rate less than or equal to 3% of spheres and have refractive index between 1.7 and 1.94, and the glass beads are sunk into 60-70% depth of the color printing layer.

During production, glass beads are planted on its surface with a thermoplastic PE material as carrier to embed a part of the glass beads into the thermoplastic PE material and project the other part of the glass beads on the surface of the thermoplastic PE material, and the glass beads are settled at 30-40% depth of the thermoplastic PE material; a film is plated on the surface of projected glass beads to form a reflective layer, and the film is made of aluminum or silver; ink patterns are printed on the surfaces of the reflective layer and the thermoplastic PE material to form a color printing layer; resin is evenly coated on the surface of the color printing layer to form an elastic resin layer; the elastic resin layer is combined with the fabric when it is half-dried to form a fabric layer; after forming, the thermoplastic PE material is peeled off from the glass beads to form the product.

Compared to the prior art, the invention has beneficial effects: on the premise of maintaining the reflective effect, the invention employs a printing method to give the material the color diversity and longer service life, and make this type of reflective material be better applied in production of fashionable clothing.

### BRIEF DESCRIPTION OF THE DRAWINGS

FIG. 1 is the sectional structural representation of the invention; and

FIG. 2 is the planar structural representation of the invention.

In the drawings, 1—fabric layer, 2—elastic resin layer, 3—color printing layer, 4—reflective layer, and 5—glass beads.

### DETAILED DESCRIPTION

The technical schemes in the examples of the invention will be clearly and fully described below in conjunction with the accompanying drawings in the examples of the invention, and it is obvious that described examples are only a part of examples of the invention, but not all examples. Based on the examples of the invention, all other examples obtained by one of ordinary skill in the art without creative work fall within the scope claimed by the invention.

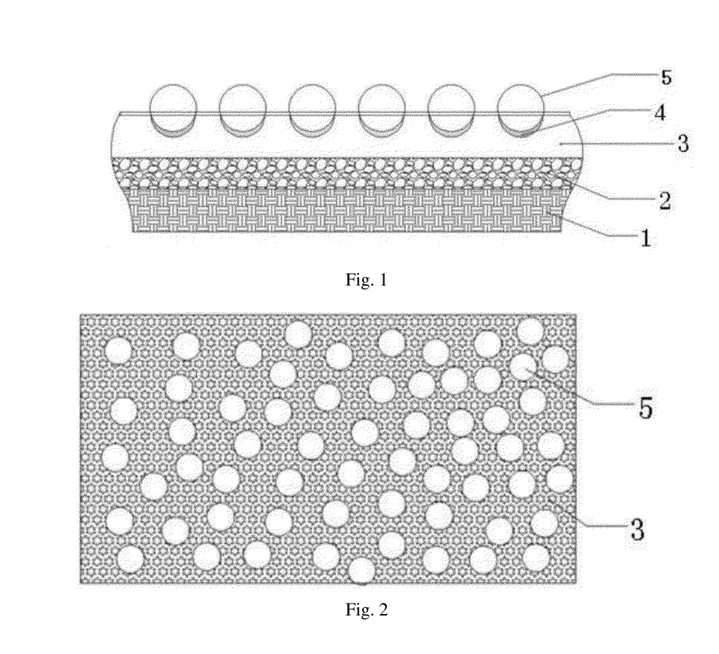

Referring to FIGS. 1-2, a reflective fabric with color printing and fabrication method thereof, includes glass beads 5, a reflective layer 4, a color printing layer 3, an environment friendly elastic resin layer 2 with environmental protection effect, and a fabric layer 1. The back hemispheroid of the glass bead 5 is covered with the reflective layer 4, the glass beads have refractive index between 1.7 and 1.94, and the reflective layer 4 is transparent or grey, has thickness of 100-200 Å and is covered on the back surface of the glass bead layer 5. The front surfaces of glass beads form multilayer and multicolor color printing by intaglio printing or silk screen printing or flexography printing or digital printing with transparent ink. The glass beads 5 are planted at 60-70% depth of the color printing layer 3; the elastic resin layer 2 is covered on the surfaces of the glass beads 5 with the reflective layer 4 and the color printing layer 3, and the lower part of the elastic resin layer 2 is connected with the fabric layer 1; the reflective fabric with color printing has overall thickness of 175-485 μm, wherein the thickness of the fabric layer 1 is 50-300 μm, the thickness of the elastic resin layer 2 is 60-115 μm, the thickness of the reflective layer 4 is 100-200 Å, the thickness of the color printing layer 3 is 5-10 μm, and the diameter of the glass beads 5 is 60 μm.

The fabrication process is as follows: the first step, glass beads 5 are planted on the surface of a thermoplastic PE material as a carrier to control settlement rate of the glass beads 5, thus embedding a part of the glass beads 5 into a thermoplastic PE material and projecting the other part of the glass beads on the surface of the thermoplastic PE material, and the glass beads 5 are settled at 30-40% depth of the thermoplastic PE material; the second step, a film made of aluminum or silver is plated on the surface of projected glass beads 5 to form a reflective layer 4; the third step, ink patterns are printed on the surfaces of the reflective layer 4 and the thermoplastic PE material to form a color printing layer 3; the fourth step, resin is evenly coated on the surface of the color printing layer 3 to form an elastic resin layer 2; the fifth step, the elastic resin layer 2 is combined with the fabric as it is half-dried to form a fabric layer 1; and the sixth step, after forming, the thermoplastic PE material is peeled off from the glass beads 5 to form the product.

It is obvious for those skilled in the art that the invention is not limited to details of above exemplary examples, and that the invention could be implemented in other specific forms without departing from the spirit or basic characteristics of the invention. Therefore, in all respects, the examples should be considered as exemplary, but not limiting, the scope of the invention is limited by attached claims rather than the above description, thus it is intended that all variations falling within the meaning and scope of equivalent elements of the claims are encompassed in the invention. Any drawing reference signs should not be considered to limit claims involved.

Furthermore, it will be understood that, although the invention is described according to embodiments, not every embodiment comprises only one independent technical scheme, the depiction way of the specification is only for clarity, those skilled in the art should consider the specification as a whole, and technical schemes in various examples could be suitably combined to form other embodiments that could be understood by those skilled in the art.

What is claimed is:

1. A fabrication method of reflective fabric with color printing comprising:
a. planting glass beads on the surface of a thermoplastic PE material as a carrier, and controlling settlement rate of the glass beads to embed a part of the glass beads into the thermoplastic PE material and project the other part of the glass beads on the surface of the thermoplastic PE material;
b. plating a film on the surface of projected glass beads to form a reflective layer, wherein the film is made of aluminum or silver;
c. printing ink patterns on the surfaces of the reflective layer and the thermoplastic PE material to form a color printing layer;
d. evenly coating resin on the surface of the color printing layer to form an elastic resin layer;
e. when the elastic resin layer is half-dried, combing it with the fabric to form a fabric layer; and
f. after forming, peeling the thermoplastic PE material off from the glass beads to form the product.

2. The fabrication method of reflective fabric with color printing according to claim 1, wherein: in the step a, the glass beads are settled at 30-40% depth of the thermoplastic PE material.

3. The fabrication method of reflective fabric with color printing according to claim 1, wherein: in the step c, the color printing layer is formed by one or more of intaglio printing, silk screen printing, flexography printing, digital printing with transparent ink and combination thereof.

4. A reflective fabric with color printing comprising a fabric layer, an elastic resin layer, a color printing layer and glass beads, wherein the fabric layer is connected with the elastic resin layer, the elastic resin layer is connected with the color printing layer, the glass beads are embedded in the color printing layer, and a reflective layer is set on the surface of the glass beads which are embedded in the color printing layer.

5. The reflective fabric with color printing according to claim 4, wherein: the fabric layer is blend-woven by one or more of polyester cotton, all cotton, terylene, spandex and acrylon.

6. The reflective fabric with color printing according to claim 4, wherein: the elastic resin layer is a thermoplastic polyurethane elastomer layer or an acrylic elastomer layer.

7. The reflective fabric with color printing according to claim 4, wherein: the reflective layer is a transparent coated hemispheroid or a grey coated hemispheroid.

8. The reflective fabric with color printing according to claim 7, wherein: the reflective layer has a thickness of 100-200 Å.

9. The reflective fabric with color printing according to claim 4, wherein: the glass beads are solid glass beads with both ellpticity and devitrification rate less than or equal to 3% of spheres and have refractive index between 1.7 and 1.94.

10. The reflective fabric with color printing according to claim 4, wherein: the glass beads are sunk into 60-70% depth of the color printing layer.

11. The reflective fabric with color printing according to claim 5, wherein: the glass beads are sunk into 60-70% depth of the color printing layer.

12. The reflective fabric with color printing according to claim 6, wherein: the glass beads are sunk into 60-70% depth of the color printing layer.

13. The reflective fabric with color printing according to claim 7, wherein: the glass beads are sunk into 60-70% depth of the color printing layer.

14. The reflective fabric with color printing according to claim 8, wherein: the glass beads are sunk into 60-70% depth of the color printing layer.

15. The reflective fabric with color printing according to claim 9, wherein: the glass beads are sunk into 60-70% depth of the color printing layer.
